(19) United States
(12) Patent Application Publication
(10) Pub. No.: US 2012/0198806 A1
(43) Pub. Date: Aug. 9, 2012

(54) LAWN DEBRIS COLLECTION ASSEMBLY

(76) Inventors: JERALD SHAY, Delavan, IL (US); LISA SHAY, Delavan, IL (US)

(21) Appl. No.: 13/021,024

(22) Filed: Feb. 4, 2011

(51) Int. Cl. A01D 43/06

(52) U.S. Cl. 56/202

(57) ABSTRACT

A lawn debris collection assembly comprising a bag and a plurality of eyelets disposed thereon. The bag comprises a front panel, a back panel, and two side panels for defining an interior portion of the bag. The bag further comprises a neck portion extending from an end portion of the bag. The neck portion is configured to removably secure to an exhaust portion of the garden tool to receive the lawn debris in the interior portion of the bag. Furthermore, the bag comprises a plurality of perforations configured on the front panel, the back panel and the two side panels of the bag for allowing air received from exhaust portion of the garden tool to escape from the bag while retaining the lawn debris in the interior portion of the bag.

### FIELD OF THE INVENTION

The present invention relates generally to collection of lawn debris, and, more particularly, to a lawn debris collection assembly removably secured to an exhaust portion of a garden tool, such as a lawn blower or a vacuum device, for collection lawn debris therein.

### BACKGROUND OF THE INVENTION

Collection of lawn debris such as trimmed grass and leaves from a lawn surface involves raking of the lawn debris into piles and thereafter transferring the piles into a trash bag. Typically, the lawn debris is manually transferred into the trash bag. However, such a manual shifting of the lawn debris into the trash bag is labor intensive and time consuming for individuals collecting the lawn debris from a large area.

For facilitating easy collection and disposal of the lawn debris, various types of garden tools such as a blower, a vacuum device and the like may be used. Typically, few garden tools are configured to operate in a blower mode and a vacuum mode. In the blower mode, the garden tool may blow the lawn debris into piles, while in the vacuum mode the garden tool may collect the lawn debris for collection thereof. More specifically, such a garden tool typically includes a collection bag removably secured to an exhaust portion of the garden tool to receive the lawn debris therein.

Although the existing collection bags are designed for convenient collection of lawn debris, they have some limitations. For example, every time when the collection bag gets filled with the lawn debris, the collection bag has to be emptied into a trash bag for subsequent use thereof. Further, manual filling of the lawn debris in the conventional collection bag and emptying the lawn debris therefrom is labor intensive and time consuming.

Accordingly, based on the foregoing, there is a need for a lawn debris collection assembly that may be used in conjunction with a garden tool for collection of lawn debris in a convenient and easy manner. Further, there is a need for a lawn debris collection assembly that reduces manual labor for removal of lawn debris. Furthermore, there is a need for a lawn debris collection assembly, which is capable of reducing the time required for removal of lawn debris from the garden tool and disposing the same. Moreover, there is a need for a lawn debris collection assembly which facilitates easy collection and disposal of the lawn debris.

### SUMMARY OF THE INVENTION

The present invention provides a lawn debris collection assembly that is configured to include all the advantages of the prior art, and to overcome the drawbacks inherent therein. Accordingly, the present invention provides a lawn debris collection assembly, which is capable of reducing manual labor and time required for removal of lawn debris. Another object of the present invention is to provide a lawn debris collection assembly, which is capable of facilitating easy collection and disposal of lawn debris. Yet another object of the present invention is to provide a lawn debris collection assembly, which is sturdy and disposable.

In light of the above objects, a lawn debris collection assembly for a garden tool according to the present invention comprises a bag, where the bag includes a front panel, a back panel, and two side panels for defining an interior portion there between. The bag further comprises a neck portion extending from an end portion of the bag. The neck portion is configured to removably secure to an exhaust portion of the garden tool to receive the lawn debris in the interior portion of the bag. Furthermore, the bag comprises a plurality of perforations configured on the front panel, the back panel and the two sides of the bag for allowing air received from exhaust portion of the garden tool to escape from the bag while retaining the lawn debris in the interior portion of the bag. The lawn debris collection assembly further comprises a plurality of eyelets disposed on at least one of the front panel, the back panel and the two side panels for receiving a strap. The strap facilitates holding of the bag. In another aspect of the present invention, a nylon mesh is disposed in the interior portion of the bag for reinforcement of the bag.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

FIG. 1 illustrates a perspective view of a lawn debris collection assembly for collecting lawn debris, in accordance with an embodiment of the present invention; and

FIG. 1A illustrates an enlarged view of an encircled portion of the lawn debris collection assembly of FIG. 1, in accordance with an embodiment of the present invention.

Like reference numerals refer to like parts throughout the description of several views of the drawings.

### DETAILED DESCRIPTION OF THE INVENTION

The present invention relates to a lawn debris collection assembly.

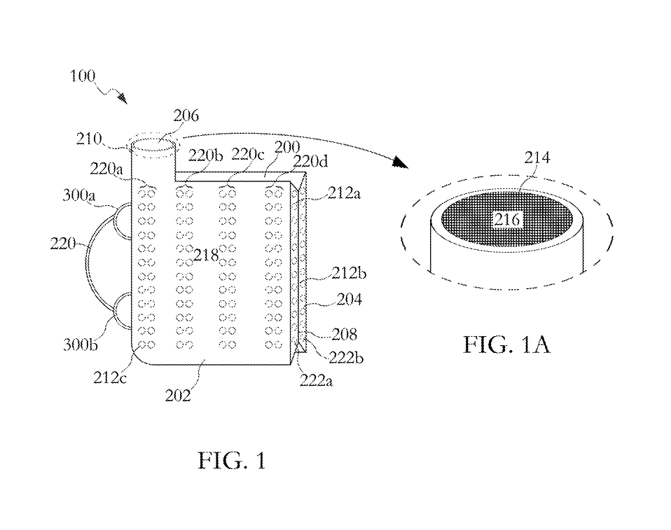

Referring to FIG. 1, and FIG. 1A, is a lawn debris collection assembly 100 for collecting lawn debris (not shown) is illustrated. More specifically, FIG. 1 illustrates a perspective view of the lawn debris collection assembly 100, in accordance with an embodiment of the present invention, and FIG. 1A illustrates an enlarged view of an encircled portion of the lawn debris collection assembly 100 of FIG. 1. The lawn debris collection assembly 100 (hereinafter referred to as the assembly 100) includes a bag 200 and a plurality of eyelets, such as an eyelet 300a, an eyelet 300b (hereinafter collectively referred to as “the eyelets 300”) disposed on the bag 200.

The bag 200 is configured to removably secure to an exhaust portion of a garden tool (not shown) to receive the lawn debris along with air passing through the exhaust portion of the garden tool. As disclosed herein, the bag 200 includes a front panel 202, a back panel (not shown) substantially coplanar with the front panel 202, and two side panels such as a side panel 204. The front panel 202, the back panel and two side panels collectively define an interior portion 206 of the bag 200 whereat the lawn debris may be collected. As shown in FIG. 1, the two side panels of the bag 200 may be foldable inwardly along a folded line, such as a folding line 208 configured on the side panel 204. Preferably, the two side panels are integral with the front panel 202 and the back panel. More specifically, the two side panels, the front panel 202 and the back panel may be formed of a single sheet taken at length. Alternatively, the front panel, the back panel, and the two side panels may include individual panels that may be attached to configure the bag 200.

The bag 200 further includes a neck portion 210 extending from an end portion of the bag 200. The neck portion 210 is configured to removably secure to an exhaust portion of the garden tool (not shown), thereby facilitating receiving the lawn debris in the interior portion 206 of the bag 200.

The bag 200 may further include a plurality of perforations, such as a perforation 212a, 212b, 212c (hereinafter referred to as the perforations 212) configured on the front panel 202, the back panel and the two side panels of the bag 200. The perforations 212 allow air received in the bag 200 from the exhaust portion of the garden tool to escape from the bag 200, while retaining the lawn debris in the interior portion 206 of the bag 200. The perforations 212 prevent excessive stretching of the bag 200 due to the escape of the air therethrough. In one particular embodiment, the perforations are arranged in equally spaced dual columns 220a, 220b, 220c, 220d along the front panel 202 and the back panel. Although, four dual columns are shown a lesser number of dual columns may be implemented to provide sufficient airflow. The perforations are spaced and sized so that a majority of the collected debris remains in the bag. Further the larger surface area of the panels remains solid or imperforated.

In one embodiment of the present invention, a mesh, such as a mesh 214 (shown in FIG. 1A) may be disposed in the interior portion 206 of the bag 200 for providing reinforcement of the bag 200. More specifically, the mesh 214 may be adhered on an inner surface 216 of the bag 200. The mesh 214 is configured to provide strength to the bag 200 for the collection of the lawn debris therein. The mesh 214 may be composed of sturdy and light weight materials, such as but not limited to a nylon material. In one embodiment of the present invention, the bag 200 may be made of a paper, such as a heavy duty paper. The heavy duty paper may provide a sturdy configuration to the bag 200.

The bag 200 may be composed of various sturdy and light weight materials, such as but not limited to a paper, a plastic and the like. Further, the bag 200 may be composed of a biodegradable material such as but not limited to paper, a biodegradable plastic and the like. The paper used for the manufacturing of the bag 200 may be a hardwearing paper configured to provide a desired strength for collection of the lawn debris. In one embodiment of the present invention, the bag 200 may be composed of a nylon material.

The bag 200 may have different capacities to collect the lawn debris, based on an area of a lawn from which the lawn debris has to be removed. In one embodiment of the present invention, the bag 200 is configured to collect about 10 gallons of the lawn debris. More specifically, capacity of “about 10 gallons” refers to a range of 5 gallons to 15 gallons. In another embodiment of the present invention, the bag 200 is configured to collect about 20 gallons of the lawn debris. More specifically, capacity of “about 20 gallons” refers to a range from 16 gallons to 25 gallons. Further, the dimensions of the bag 200 may vary according to the desired capacity of the bag 200. For example, for configuring a capacity of about 20 gallon, the bag 200 may be about 2 feet tall and about 10 inches wide.

The assembly 100 further includes the eyelets 300 disposed on at least one of the front panel 202, the back panel and the two side panels such as the side panel 204. More specifically, the eyelets 300 may be disposed on an outer surface 218 of the bag 200. The eyelets 300 are adapted to receive a strap 220 such as a shoulder strap of a user, thereby facilitating convenient holding of the bag 200 by the user.

The eyelets 300 may be coupled to the outer surface 218 of the bag 200 by means of a fastener such as but not limited to a rivet. Moreover, the eyelets 300 may be composed of various materials, such as but not limited to plastic, wood, metal or any such material, which is capable of withstanding weight of the lawn debris collected inside the bag 200.

In use, the assembly 100 may be attached to the exhaust portion of the garden tool. Thereafter, the garden tool may be operated to collect the lawn debris in the bag 200 of the assembly 100. The filled bag 200 of the assembly 100 may be removed from the garden tool and the neck portion 210 may be tied off and set out for disposal, thereby easing a burden on the user to empty the lawn debris into a separate disposable bag.

Various embodiments of the present invention offer following advantages. The lawn debris collection assembly, as described herein, enables a user to use the assembly with a garden tool, and thereafter directly dispose of the same, thereby allowing a reduction in time required for the removal of lawn debris from the bag and disposing the same in another disposable bag. Accordingly, the lawn debris collection assembly facilitates easy collection and disposal of the lawn debris. Moreover, the lawn debris collection assembly is capable of reducing the manual labor required for the removal of lawn debris. Further, the lawn debris collection assembly disclosed herein is light weight and biodegradable. Still further, the lawn debris collection assembly of the present invention is sturdy and disposable.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the claims of the present invention.

1. A lawn debris collection assembly for a garden tool, the lawn debris collection assembly comprising:
a bag, where the bag includes, a front panel, a back panel, and two side panels for defining an interior portion of the bag, a neck portion extending from an end portion of the bag, the neck portion configured to removably secure to an exhaust portion of the garden tool to receive the lawn debris in the interior portion of the bag;
a nylon mesh disposed in the interior portion of the bag for reinforcement of the bag;
a plurality of perforations configured on the front panel, the back panel and the two side panels of the bag for allowing air received from exhaust portion of the garden tool to escape from the bag while retaining the lawn debris in the interior portion of the bag, where the perforations are arranged in no greater than four equally spaced dual columns; and
a plurality of eyelets disposed on at least one of the front panel, the back panel and the two side panels for receiving a strap, the strap facilitating holding of the bag.

2. The lawn debris collection assembly of claim 1, wherein the bag is composed of paper.

3. (canceled)

4. The lawn debris collection assembly of claim 1, wherein the bag is composed of a nylon material.

5. The lawn debris collection assembly of claim 1, wherein the bag is composed of a plastic material.

6. The lawn debris collection assembly of claim 1, wherein the bag is composed of a biodegradable material.

7. The lawn debris collection assembly of claim 1, wherein the plurality of eyelets is composed of a metal.
